(19) United States
(12) Patent Application Publication
(10) Pub. No.: US 2009/0174728 A1
(43) Pub. Date: Jul. 9, 2009

(54) METHODS OF AND SYSTEMS FOR DISPLAYING SELECTED PORTIONS OF SPLIT SCREEN DISPLAYS

(75) Inventors: Vincent J. Ferrer, Pittsford, NY (US); Steven D. Smith, Rochester, NY (US); Ian Sinclair, Indian Falls, NY (US)

Correspondence Address: Stephen B. Salai, Esq.;Harter Secrest & Emery LLP, 1600 Bausch & Lomb Place, Rochester, NY, 14604-2711, US

(73) Assignee: Vuzix Corporation, Rochester, NY (US)

(21) Appl. No.: 12/251,878

(22) Filed: Oct. 15, 2008

Related U.S. Application Data
(60) Provisional application No. 61/019,233, filed on Jan. 4, 2008.

(51) Int. Cl. G09G 5/00; A63F 13/00

(52) U.S. Cl. 345/619; 463/40

(57) ABSTRACT

A system for manipulating the appearance of a video signal includes an input, a user interface, and a processor. The input receives a video signal displayable as a video image in an active video field. The video image includes a plurality of sections. The user interface accepts a user input to select one of the plurality of sections. The processor manipulates the video signal to display the selected one or more of the plurality of sections of the video image on a display associated with the user.

### RELATED APPLICATION

This application claims the benefit of U.S. Provisional Patent Application No. 61/019,233, filed Jan. 4, 2008.

### BACKGROUND OF THE INVENTION

1. Technical Field

The present invention relates generally to videos and video gaming. More specifically, the invention relates to methods for presenting a section of a split-screen display to a user.

2. Description of Related Art

The present invention relates generally to discriminating amongst portions of a displayed image and displaying to a user less than all of the discriminated portions. Although not limited to this application, the present invention is particularly useful for multiplayer video games in which a single display conventionally is shared by multiple players. For example, when two players are pitted against each other in a game, the screen conventionally is split either horizontally or vertically to accommodate the view seen by the first player in one area and the view seen by the second player in another area. Similarly, when multiplayer mode consists of allowing 3, 4, or even more players to participate, the display is segmented into a corresponding number of discreet areas, each area showing the playing screen for the specific user. Accordingly, when four players are participating, it is not uncommon for a display to be broken into four quadrants, one in each of the top left, top right, bottom left, and bottom right portions of the screen.

With these conventional methods of displaying multiplayer images on a single screen, problems have arisen because each player is able to see his or her opponent's screen. Thus, each player has no privacy from the other players, which can lead to unfair advantages. In addition, extraneous information displayed to a user can be distracting and possibly limit the user's ability to concentrate or otherwise achieve the goal of the game.

Accordingly, there is a need in the art for improved methods and systems for displaying multiplayer games individually to multiple users.

### SUMMARY OF THE INVENTION

The present invention remedies the foregoing needs in the art by providing a more “singular” approach, which allows a user to select only the portion of the screen pertinent to his or her playing of the game to display only that portion to the user. Accordingly, the present invention allows a user to view the video game in a manner similar to a single player scenario, but while still playing in a multiplayer scenario.

In one aspect, the present invention relates to a system for manipulating the appearance of a video signal. The system includes an input, a user interface, and a processor. The user input receives a video signal displayable as a video image in an active video field. The video image includes a plurality of sections. The user interface accepts a user input to select one of the plurality of sections. The processor manipulates the video signal to display only the selected one or more of the plurality of sections of the video image on a display associated with the user.

In another aspect of the invention, a method of presenting selective portions of a multiplayer video game to one or more of a plurality of players includes providing a video game signal including video information comprising a plurality of pixels. The method also includes determining from the video game signal a first set of pixels comprising video information for viewing by a first player and a second set of pixels comprising video information for viewing by a second player, and displaying the first set of pixels on a first display and the second set of pixels on a second display

In yet another aspect of the invention, a system for playing video games includes a video source, a video decoder, a user interface, and a video processor. The video source outputs a video signal comprising pixels for displaying in an active video field. The video decoder decodes the video signal output from the video source. The user interface accepts an input from a user corresponding to a user selected portion of the active video field and outputs a selection signal corresponding to the user input. The video processor receives the decoded video signal from the video decoder and the selection signal from the user interface and manipulates the decoded video signal to render a display according to the user input.

These and other aspects and features of the invention will be appreciated with reference to the following detailed description and accompanying figures, in which the invention is described and illustrated.

### BRIEF DESCRIPTION OF THE DRAWING FIGURES

FIGS. 1A and 1B are illustrations of conventional layouts in multiplayer game scenarios.

FIG. 2 is a depiction of a conventional streaming video format.

FIG. 3A is a block diagram showing hardware for decoding video signals and performing embodiments of the invention.

FIG. 3B is a block diagram showing hardware for decoding video signals and performing embodiments of the present invention.

FIGS. 4A, 4B, and 4C are a flow chart and two timing charts illustrating preferred embodiments of the present invention.

FIGS. 5A, 5B, and 5C are a flow chart and two timing charts illustrating preferred embodiments of the present invention.

FIG. 6 is a flow chart showing additional embodiments according to the invention.

FIG. 7 is a block diagram showing a hardware setup according to a preferred embodiment of the invention.

FIG. 8 is a depiction of a system including a number of display devices connected in a multiplayer scenario.

### DETAILED DESCRIPTION OF THE INVENTION

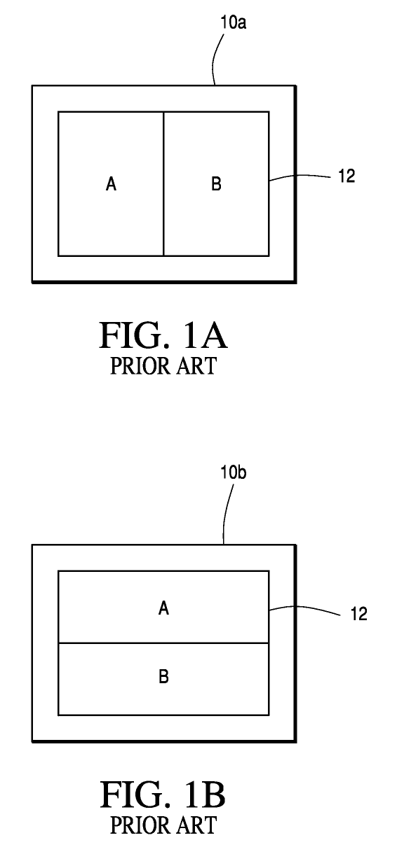

In a first embodiment of the invention, each of FIGS. 1A and 1B depicts a monitor 10a, 10b on which a multiplayer game is depicted. Shown schematically therein, the multiplayer game is broken into two portions, A and B, for respective use by two players, 1 and 2. During normal play of the game, user 1 is concerned only with the image depicted on portion A of the screen, and user 2 is concerned only with the portion of the display shown in portion B of the screen. FIG. 1A depicts a horizontally-split scenario, in which sections A and B are arranged next to each other on the display 10a. FIG. 1B is a similar embodiment, but in which with the screen sections A and B are arranged one on top of the other on the display 10b, in a vertically-split scenario. FIG. 1A and FIG. 1B both illustrate generally scenarios that avail themselves to the processing of the invention, which includes discriminating between portion A of the image and portion B of the image and presenting on a single display only portion A to the first user and on a second display used by the second user, portion B.

While the invention can certainly be used with multiple TV's, computer monitors, or the like, it is also envisioned that the device may be used with personal video display glasses, such as those made by Vuzix Corporation and sold under the trade name IWEAR.

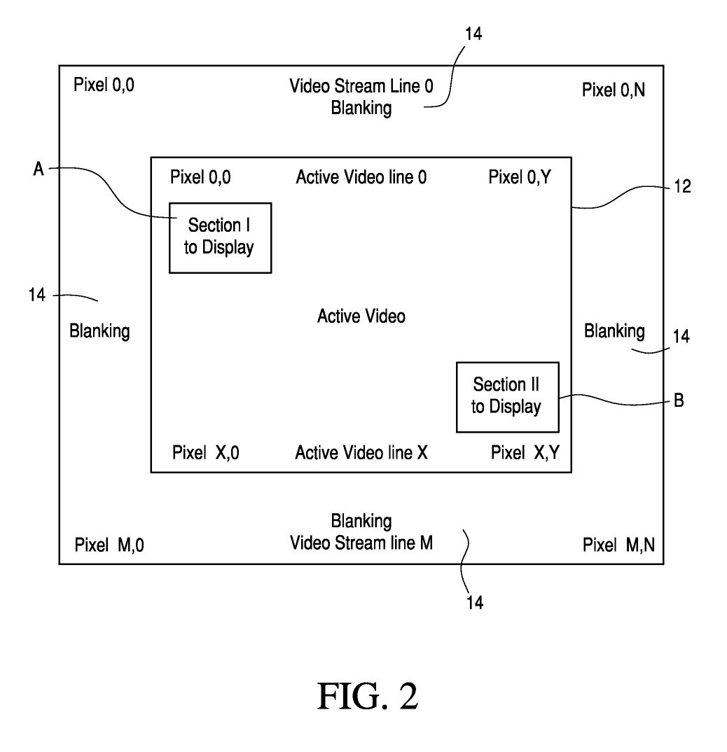

FIG. 2 is a schematic representation generically showing the two embodiments of FIGS. 1A and 1B, described above. As shown therein, two sections (I and II, corresponding to sections A and B described above) are displayed within an active video field 12 and as will be described in more detail below, the two sections, section A and section B in FIG. 2 are to be displayed separately on separate displays. As illustrated in FIG. 2, the two sections are disposed within the active video field 12 and are generally described according to pixel locations (0, 1, 2, . . . , Y, in the horizontal direction) on active video lines (0, 1, 2, . . . , X). As also illustrated in FIG. 2, the active video portion 12 is generally a subset or subportion of the entire video feed, which generally includes blanking regions 14 surrounding the active video region 12. The entire vide feed, including blanking region, is illustrated in FIG. 2 as a filed M lines tall×N pixels wide. This arrangement is generally well known to skilled practitioners. As will also be appreciated from the following description, there may be more than two sections, and the sections may be arranged in non symmetric or uneven-shaped patterns.

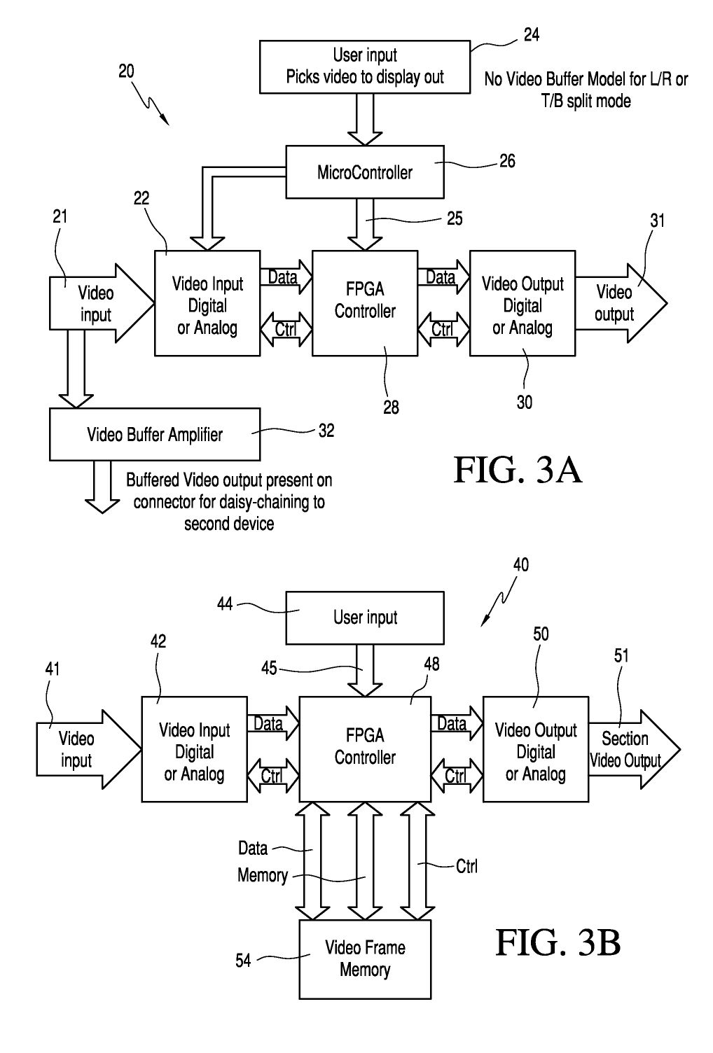

FIG. 3A is a block diagram illustrating a hardware arrangement for implementing the methods of the present invention. As generally illustrated therein, an apparatus 20 according to the invention includes a video input module 22 (or video decoder), a user input module 24 with an associated microcontroller 26, a video processor 28 (illustrated as an FPGA controller), and a video output module 30 (or video encoder). In general operation, the video decoder 22 receives a video signal 21 from a video source (not shown in FIG. 3), which may include a gaming console or some other computing system on which the video signal is derived. The decoded video signal is then sent to the video processor 28. The video processor 28 also receives an input 25 from the user input module 24, which preferably allows a user to choose between a plurality of display options. The options for choosing by the user include at least (i) a full field display in which the video signal is displayed as was intended, namely, all the lines and pixels in the active video are shown, and (ii) a partial display, in which only some portion of the active video is shown to the user. The user input module preferably includes controls to select amongst a number of partial display options, including, but not limited to, a mode in which one of the left and right halves of the screen can be displayed, and another mode in which one of the top and bottom halves of the display is shown to the user. As will be appreciated from the description, other modes also may be chosen to show regions of the active video display other than what has just been described.

As noted above, the user-chosen display mode is received by the video controller. Once received, the video controller manipulates the decoded video signal to output a video signal 31 that will present the display to the user in the chosen mode. Before being displayed, the video signal output by the processor may be encoded using a video encoder, for compatibility with the display device. Also illustrated in FIG. 3B is a video buffer/amplifer 32. This feature will be described in more detail below, and can be useful to feed input video signal to another apparatus having a separate display device.

FIG. 3B represents another apparatus 40 similar to the apparatus 20 of FIG. 3A. This apparatus 40 also includes a video input 42 receiving a video input signal 41, a user input 44 generating a signal 45 for sending to an FPGA controller 48 and a video output 50 outputting a video output signal 51 to a display. The apparatus of FIG. 3B also includes a video frame memory 54, which will be described in more detail below.

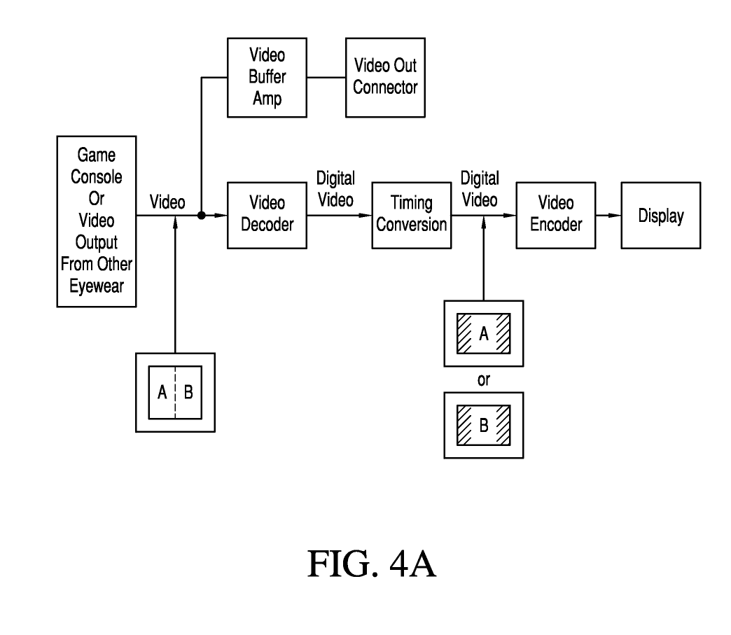

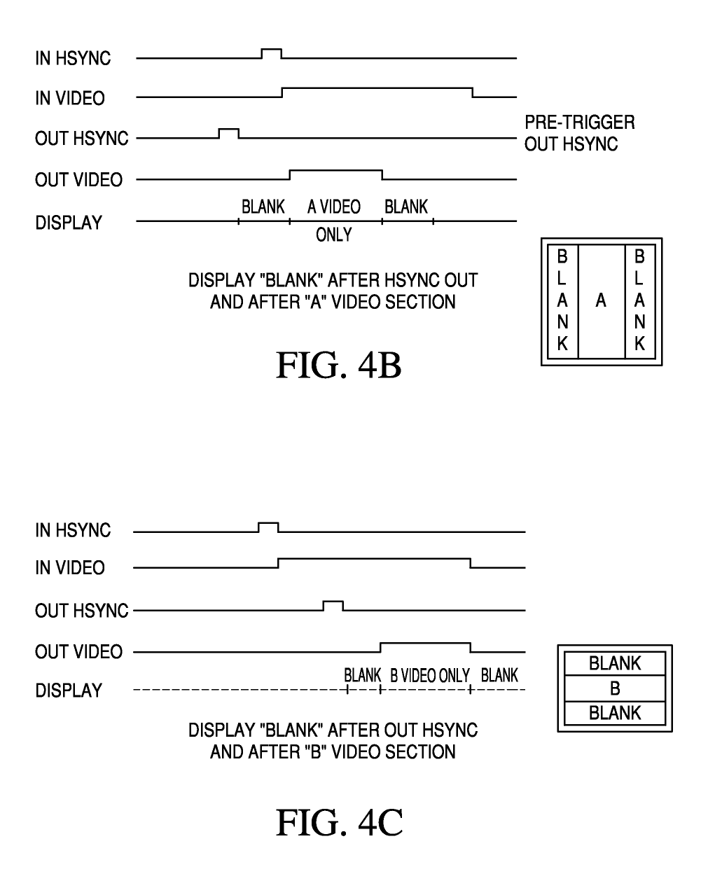

Exemplary processing according to preferred embodiments of the invention now will be described with reference to FIGS. 4A-4C. Of those Figures, FIG. 4A illustrates a block diagram similar to that of FIG. 3A, but with the original or native video signal output from the gaming console intended to be displayed in the manner illustrated in FIG. 1A, i.e., with portion A being displayed on the left side of the screen and portion B on the right side of the screen. Depending upon the user selection, i.e., the user selection to view either portion A or portion B, the processing of the video signal will be done as illustrated in FIGS. 4B and 4C, respectively.

FIG. 4B shows a timing chart illustrating the scenario in which the user selects to view the left hand side (portion A) of the two person, horizontally-split multiplayer display. The input video signal includes a horizontal sync (IN HSYNC) defining the start of each line in the frame followed temporally by the row of pixels comprising the specific line. Because only the first half of each line is desired to be shown to the user, however, the video signal output by the processor has an OUT HSYNC that occurs before the IN HSYNC. Directly following the OUT HSYNC for the video displayed to the user is a video signal showing a blank, in this case, all black pixels. In the preferred embodiment, the number of black pixels shown in this blank portion approximates one-quarter of the width of the display. Directly following the blank portion, the output video signal tracks the in video signal, namely, to show the input video signal beginning at the beginning of the input line. However, instead of showing the entire input video signal, only the first half of the input video signal is shown. After the first half of the input video signal is shown, a blank region is generated by the video controller. In the illustrated embodiment, this blank portion is again a series of black pixels, and those pixels comprise the last quarter of the displayed row. As will be appreciated, as successive lines are read out on the display screen, the user sees in the horizontal center of the screen the portion A of the video signal output by the console surrounded on either side by two black strips. Thus, the user is presented only with the portion of the game with which he is concerned.

Thus, section A of the two part video display is shown to the user by adjusting the timing of the H sync and controlling the amount of the input video signal that is subsequently output to the display screen. The H sync of the output video image is pre-triggered i.e., before receiving the H sync of the input video. Between this pre-triggering, and a display of the input video, black video is shown on the output. Similarly, after the first half of the input display video is shown, a black video is again displayed until the next H SYNC. Effectively, each line of the input video signal is shifted approximately one-quarter of the way across the screen (horizontally) and only approximately the first half of each line is displayed.

FIG. 4C illustrates a timing pattern similar to that of FIG. 4B, but illustrates the manner in which the right-side, or B, portion of the display is displayed to the user concerned with that section of the display. The H sync and IN video are received from the gaming console in the same manner in which they are received in the embodiment in which Section A of the video signal is illustrated. However, the H sync for the VIDEO OUT (the OUT HSYNC) is triggered after the H sync of the video in and, like in the display for FIG. 4B, the H sync for the video out is followed by a blank portion. In this embodiment, a series of black pixels are used for the blank portion. The video OUT signal then tracks the IN video through the completion of the IN video signal, namely, to display the second half of each line of the IN video signal. Upon completion of displaying the input video signal, each line is completed with a blank portion, which in this embodiment is again a series of black pixels. Effectively, the foregoing process and apparatus allows the right half of the original active video field (section B) to be shifted left (in the horizontal direction) approximately one quarter the width of the display with only section B being shown, bounded on either side by a blank region.

As should be appreciated, the ability to display both the A portion of the display screen and the B portion of the display screen simultaneously but separately requires two video displays, one unique to each user in the multiplayer scenario. Thus, two processers generally are needed, one to process the input video signal to display the A portion and a second to process the input video signal to display the B portion. The embodiment illustrated in FIG. 4A shows that the input video signal is split prior to decoding for manipulation of subsequent display of only a single portion of the display. To this end, the present invention as illustrated in FIG. 3A, anticipates using the video buffer amp and a “video out” connector to send the video signal for processing by a second processor corresponding to the second display, thus negating the need for a separate video splitter device.

In one embodiment, the present invention could be implemented as a single “black box” that includes multiple processors and multiple video outputs, each one being configurable to output a video signal corresponding to a display of one of the portions to be viewed by the individual user. For example, this black box could be incorporated into the video game console or other video signal origination device. However, and as noted above, the invention also is useful with personal video display devices. Accordingly, it may be desirable to “daisy chain” a plurality of personal video displays. Thus, the first user would be connected directly to the console, where as a video output from the first personal video display device is then in communication with an input of a second video display device. In one embodiment, an output could be a configurable audio and/or video output that would receive a connector receivable on the opposite end in the video input portion of a second personal video device. Of course, wireless connections also could be used.

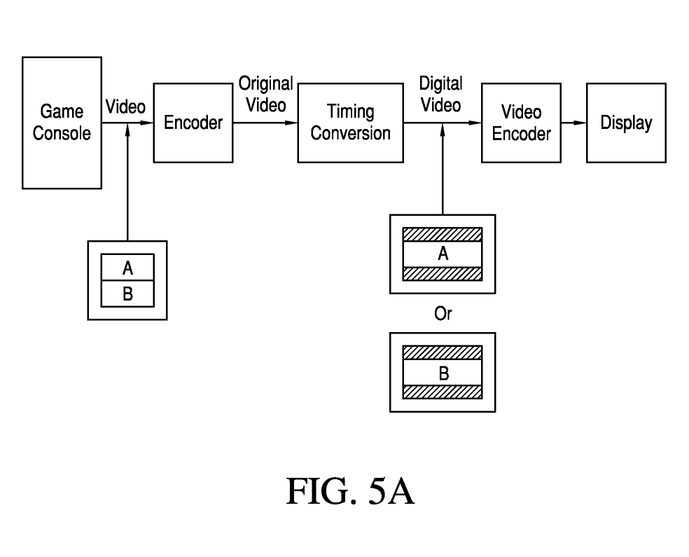

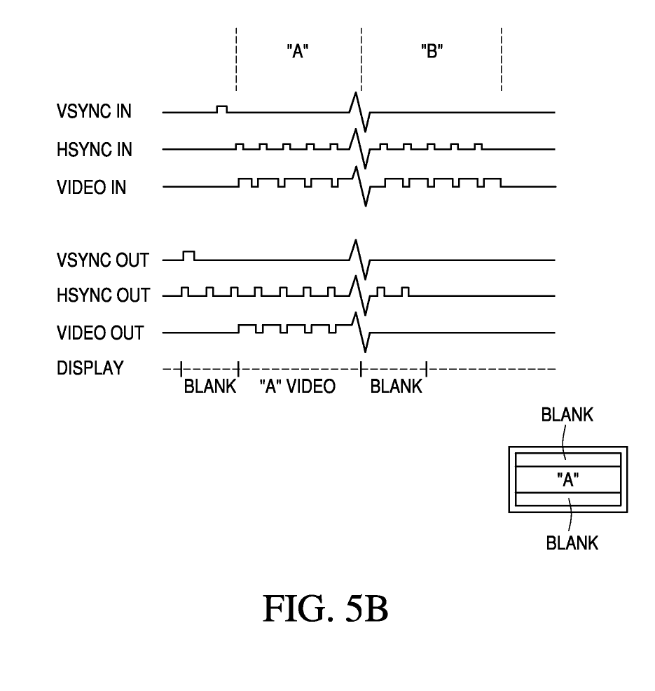

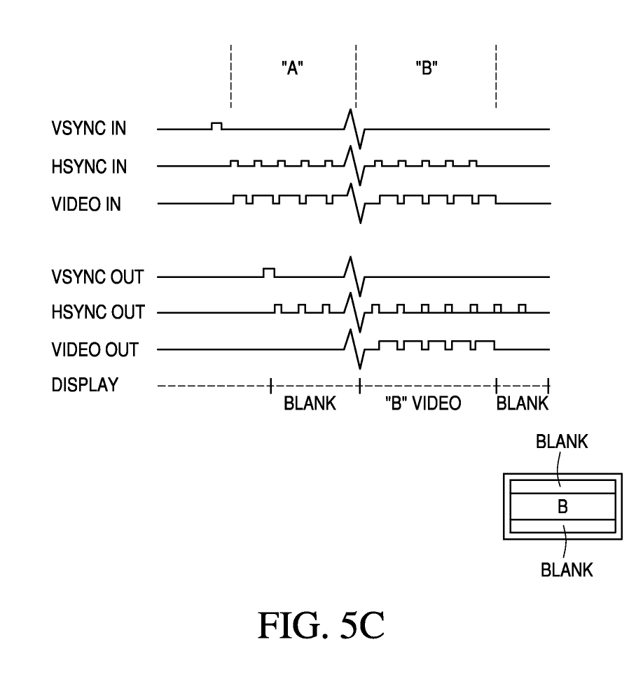

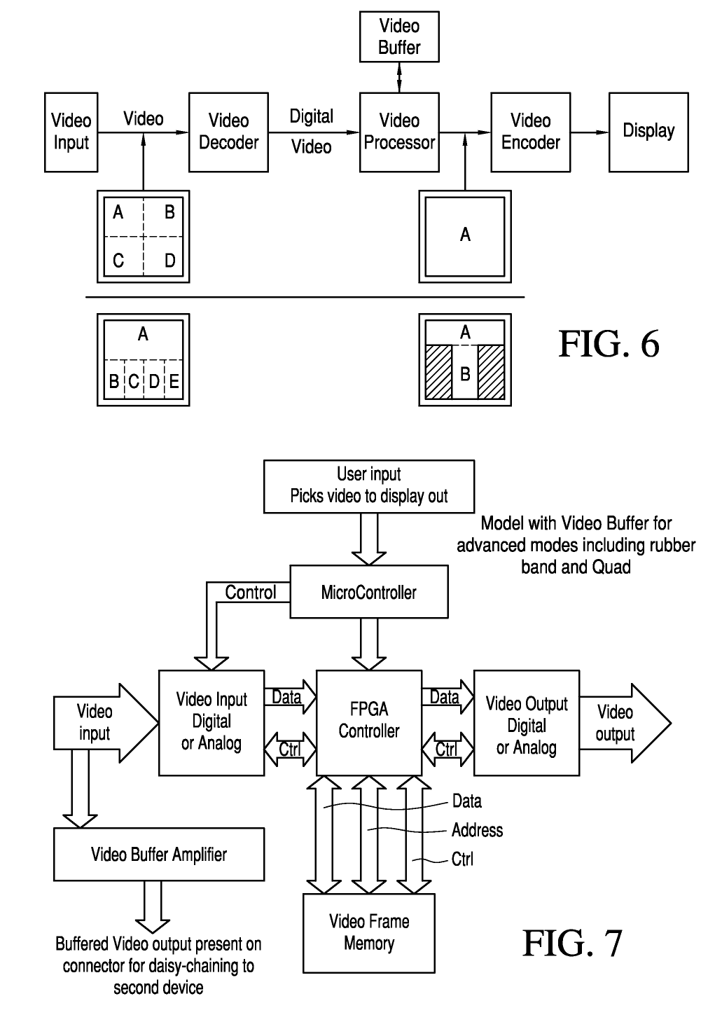

FIGS. 5A-5C illustrate additional diagrams similar to those of FIGS. 4A-4C, but in which the A and B portions of the video display are in a vertical orientation, namely, one on top of the other in the video signal output by the video source. This embodiment is similar to the embodiment described above for horizontally-split screens, but in this embodiment, the timing of the V sync is adjusted as opposed to that of the H sync. Specifically, when it is desired to show the A, or top, portion of the screen, a time shift is applied as depicted in FIG. 5B, such that the V sync of the output video is pre-triggered in relation to the V sync of the input. The V sync of the output preferably is followed by a series of all blank lines, which in turn are followed by a number of lines corresponding to a top half of the original video display and then another series of blank lines. The appearance then provided to the user is of a first horizontal blank band at the top of the screen and a similar band at the bottom of the screen, preferably each being approximately one-quarter the height of the screen. Sandwiched between the two bands is the first player or A portion of the input video signal. In this embodiment, the A portion is shifted downer on the user display approximately one quarter the height of the display screen, and the B portion is not shown.

As illustrated in FIG. 5C, when section B of the split screen is to be displayed to a user, the output V sync is triggered after the input V sync and after a portion of the input video, and is followed by a series of black lines. These black lines are then followed by output of the original video signal, namely, the B portion of the video signal. The lines output after that are preferably blank lines. Like in the discussion above for the A portion, the second player, or the user desiring to see the B portion of the video signal now sees blank (black) horizontal bands at the top and bottom of his frame, sandwiching the B portion of the video signal. In this embodiment, the users see only the portions of the display relevant to their game-playing experience.

As will be appreciated, although in these embodiments it is illustrated that the portion desirable to each of the users is centered on the screen, such is not necessary. For example, the user desiring to see the A portion may not want their portion moved. In this scenario, the B portion of the signal is merely read out as blank pixels. Moreover, the invention is not limited to use of black pixels for the blank regions. White pixels or any other coloration could be used. Alternatively, the blank regions could display designs or text or any other useful information, as desired by the programmer.

The invention has been described for two-player scenarios, but it also is known to have scenarios including more than two players at a time. When more than two portions of the screen are presented to the multiple users aligned in a vertical orientation or in a horizontal orientation, the displays can be done in the same manner as described above for two display portions A and B. More often, however, the views will not be aligned. For example, most a four person scenarios are displayed on quadrants of the screen. These quadrants generally are arranged at the upper left, upper right, lower left and lower right areas of the display, and these quadrants could be individually shown by applying a combination of the methods described above. Namely, for showing the top left quadrant, both the H sync and V sync for the output signal would be pre-triggered with respect to the input video signal. In this manner, a blank area could be shown above and to the left of the A portion, the center of the screen would than contain only the A portion, and a blank portion would also be to the right and below the A portion.

Because the aspect ratio of each of the four quadrants may be similar to the overall aspect ratio of the display, it may be desirable in this four-player mode to enlarge each quadrant to closely fit the entire viewing area of the display. To this end, the device in FIG. 7 illustrates an alternative embodiment in which a video frame memory or frame buffer is provided in communication with the FPGA controller or other video processing device (similar to the embodiment of FIG. 3B). Specifically, the video buffer allows storing a frame or portion of a frame of data before displaying to the user, to enable manipulation of the signal prior to display. In this preferred embodiment in which four quadrants are present in a four person multiplayer scenario, each of the quadrants or sections preferably is scaled up prior to being displayed on the displays to alleviate some or all of the framing around the to-be-displayed portion. The video buffer may also be used in either of the earlier scenarios described above. For example, it may be desirable to stretch the portions A and B of the embodiments described above to more completely fill the display area.

FIG. 7 schematically shows the four-quadrant embodiment described above, as well as another four-player scenario. Specifically, this alternative four player scenario involves a header (A) of information that is common to all players and four portions (B-E) for the four players. In this embodiment, the first player should be shown the header A as well as their relevant game-playing section, which in the example is section B. Using the methods described above, the present invention allows such a display for the user. Moreover, the section B is preferably centered below the header A.

While the present invention has been described thus far in relation to embodiments in which the portion of a screen to be displayed individually are pre-established, in a still further embodiment of the invention, the user can select a section of the original video to be displayed on that user's display screen. For example, a pointing and clicking device can be used to identify some portion of the display that the user would prefer to only see on his or her display. In this instance, a video buffer may also be required to manipulate each frame of the video signal to parse out only those portions that should ultimately be displayed to the user. One of ordinary skill would appreciate the plurality of input methods or user interfaces that would enable selection of portions of active video. One would also appreciate the option of selecting several different sections of video and rearranging the placement of such sections to the benefit and preference of the user.

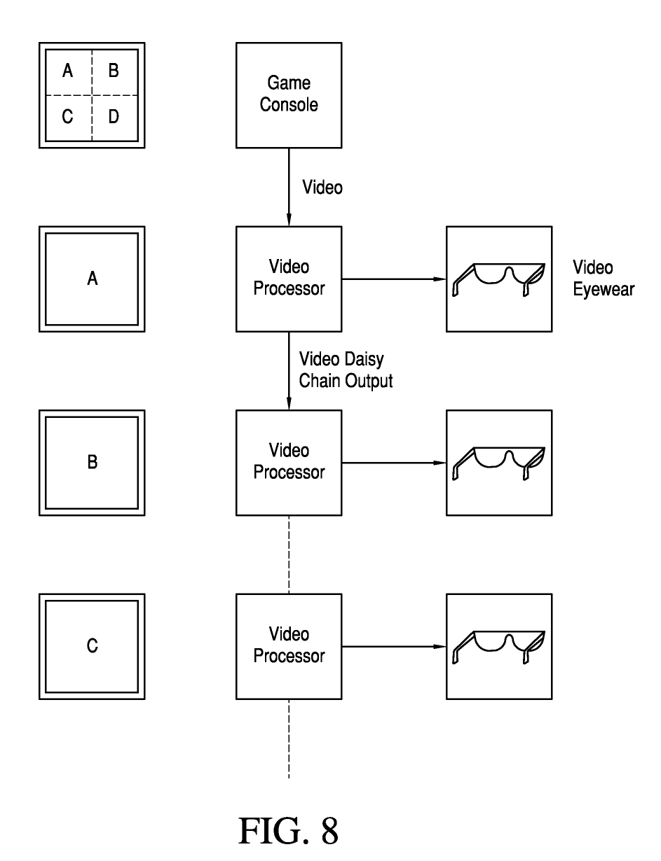

As described above, the invention preferably is used with personal video display devices. FIG. 8 shows a series of three conventional video display devices. Each includes a wearable frame including temples and ear pieces and a front portion housing a pair of LCD screens, one each for registration with a users left and right eyes.

Each video display device preferably also includes a user controller. The controller generally includes an on/off switch and may include other controls including volume, brightness and/or contrast controls, and power functions. It is preferably on this control that the user also can make a decision as to what portions or how much of the standard image is to be displayed on his specific display. For example, a user may choose to show all of the image, may choose to show a left or right portion of horizontally-aligned images, a top or bottom portion of vertically-aligned images, or one of four quadrants in a standard four quadrant multiplayer application. As noted above, the controller may also include an input button or a moveable device that would allow for pointing and clicking or some other selection device for choosing a portion of the display to be shown. The first personal video display device preferably also includes an output that relays the video signal output from the console to the second video display device. As illustrated in the Figures previously discussed, an amplifier and a buffer preferably are used to assist in this relaying of video signal to the second personal video display device. Thus, each user has controls to choose the portion of the display screen which he or she would like to use but only a second output from a console is necessary. Accordingly, the users can each play the same game or view the same content but with only one output of the video.

In a preferred embodiment of the invention, when the video signal is a VGA signal, the video decoder may be made by Analog devices, such as part no. AD9883. When the signal is an NTSC signal, Techwell's TW9910 may be used as the video decoder. The video processor is preferably an FPGA processor, although such is not required. The processor may be XC35100E from XILINX or a custom application specific circuit. The video encoder is generally specific to the display and may not be required in some embodiments. A known video buffer memory is IS61LV25616AL-ISSI 256×16 SRAM. The displays may be any number of displays, including a KOPIN color VGA such as the 640×480 AMLCD display provided as KCD-VDCF-BA.

Alternatively, the functioning of the invention can be included in the gaming console, the video game, or another point of origin of the video signal. For example, appropriate controls could be included in the console to establish selective video display portions for output. In this embodiment, multiple ports could be included for a user to plug their display device into, i.e., to choose between a first output, a second output, etc. Alternatively, one output could be provided with a selection being made either by the device or by the user about which portion of the active video field would be output.

To implement the present invention, the number of lines and pixels that make up each section may be pre-established by the processor, or may be provided in information contained with the video signal from the console. Moreover, the processor may auto-detect the presence of a continuous vertical or horizontal line and recognize such line as a division between adjacent sections.

When the portion is displayed with one or more blank bands, i.e., horizontal or vertical black bands as in the embodiments described above, the video signal (the A or B portion) may also be movable with respect to the bands. For example, for a personal video display device, a head tracker may be used in connection with the video processor to manipulate the position of the displayed portion A or B on the display screen. Such head trackers may incorporate gyroscopes, accelerometers or magnetic field sensors. In one embodiment, a 3-axis gyroscope is used to detect the rotation about the three axes of the user's head and a smoothing function is applied to the output video signal to smooth the motion of the video image on the microdisplay based on the computed movement of the user's head. This will reduce the sensation that the video image is head-borne and more placed in space like a movie, television or other type of display screen. The degree of smoothing would be a user preference set by the user interface controls or could be pre-established by the programmer.

The present invention has been described with reference to specific, preferred embodiments of the invention. The foregoing embodiments of the invention are representative embodiments, and are provided for illustrative purposes. The embodiments are not intended to limit the scope of the invention. Variations and modifications are apparent from a reading of the preceding description and are included within the scope of the invention. The invention is intended to be limited only by the scope of the accompanying claims.

We claim:

1. A system for manipulating the appearance of a video signal, comprising:
an input receiving a video signal displayable as a video image in an active video field, the video image including a plurality of sections;
a user interface receiving an input from a user to select one of the plurality of sections; and
a processor for manipulating the video signal to display the selected one or more of the plurality of sections of the video image on a display associated with the user.

2. The system of claim 1, wherein each section is associated with a different user.

3. The system of claim 1, wherein the plurality of sections comprises first and second sections arranged one of horizontally and vertically in the active video field.

4. The system of claim 3, wherein the processor manipulates the video signal to display only one of the first and second sections substantially centered on the display associated with the user.

5. The system of claim 3, wherein the processor manipulates the timing of at least one of an input H sync and an input V sync associated with the received video signal with respect to one of a respective corresponding output H sync and an output V sync used for displaying a selected one of the first and second sections.

6. The system of claim 5, wherein the first and second sections are arranged vertically, the received video signal comprises the input H sync for each of the lines in a frame comprising the video image, and wherein the processor manipulates the timing of the input H sync to one of before and after the output H sync.

7. The system of claim 5, wherein the first and second sections are arranged horizontally, the received video signal comprises the input V sync for each of the frames comprising the video image, and wherein the processor manipulates the timing of the input V sync to one of before and after the output V sync.

8. The system of claim 5, wherein an output video signal sent by the processor to the display comprises only a portion of the received input video signal.

9. The system of claim 8, further comprising outputting from the processor a number of pixels other than those from the received input video signal.

10. The system of claim 9, wherein the number of pixels are blank pixels.

11. The system of claim 1, further comprising a second display associated with a second user, the second display displaying a second of the plurality of sections different from the selected one or more of the plurality of sections.

12. A method of presenting selective portions of a multiplayer video game to one or more of a plurality of players, comprising:
providing a video game signal including video information comprising a plurality of pixels;
determining from the video game signal a first set of pixels comprising video information for viewing by a first player and a second set of pixels comprising video information for viewing by a second player; and
displaying the first set of pixels on a first display and the second set of pixels on a second display.

13. The method of claim 12, further comprising:
forming a first output video signal including information corresponding to the first set of pixels and outputting the first output video signal for display in the displaying step; and
forming a second output video signal including information corresponding to the second set of pixels and outputting the second output video signal for display in the displaying step.

14. The method of claim 13, wherein at least one of:
the first output video signal is formed to present the first plurality of pixels in a first predetermined position on the first display, and
the second output video signal is formed to present the second plurality of pixels in a second predetermined position on the second display.

15. The method of claim 12, further comprising receiving a user input from a user input device defining the first set of pixels and the second set of pixels.

16. A system for playing video games, comprising:
a video source outputting a video signal comprising pixels for displaying in an active video field;
a video decoder for decoding the video signal output from the video source;
a user interface accepting an input from a user corresponding to a user selected portion of the active video field and outputting a selection signal corresponding to the user input; and
a video processor receiving the decoded video signal from the video decoder and the selection signal from the user interface and manipulating the decoded video signal to render a display according to the user input.

17. The system of claim 16, wherein the user input identifies a first portion of the active video field to be displayed on a first display device viewable by the user.

18. The system of claim 17, wherein a second portion of the active video field, different from the first portion, is displayed on a second display device.

19. The system of claim 18, wherein the second display device is not viewable by the user.

20. The system of claim 17, wherein the portion of the active video field not included in the first portion is manipulated to be imperceptible and the entire active video field is displayed on the first display device.
